(19) United States
(12) Patent Application Publication
(10) Pub. No.: US 2026/0220912 A1
(43) Pub. Date: Jul. 30, 2026

(54) SYSTEMS FOR TARGETED IMAGE SAMPLING

(71) Applicant: Walmart Apollo, LLC, Bentonville, AR (US)

(72) Inventors: Raghava Balusu, Achanta (IN); Abhinav Pachauri, Banglore (IN); Han Zhang, Allen, TX (US); Avinash Madhusudanrao Jade, Bangalore (IN); Mingquan Yuan, Flower Mound, TX (US); Lingfeng Zhang, Flower Mound, TX (US); Zhaoliang Duan, Frisco, TX (US); William Craig Robinson, Centerton, AR (US)

(21) Appl. No.: 19/040,796

(22) Filed: Jan. 29, 2025

(51) Int. Cl. G06V 10/762; G06F 16/583; G06Q 30/0601; G06V 20/70

(52) U.S. Cl. CPC G06V 10/762; G06F 16/583; G06Q 30/0609; G06V 20/70

(57) ABSTRACT

Systems and methods for sampling item data. One such method includes receiving, from for each of a plurality of items, a recognition rate corresponding to a rate of success of correlation between: image data of the item captured by an image capture device, and an identified selection of the item from item selection data generated by an item tracker configured to generate the item selection data for lists of selected items. The method further includes determining, from the plurality of items, a plurality of target items having recognition rates failing to satisfy a recognition threshold; identifying, from the item selection data, a plurality of candidate items lists each including at least one of the plurality of target items; determining, by the computing device, a group of top items lists from the plurality of candidate items lists; and retrieving, by the computing device, image data associated with the top selected-items lists.

### BACKGROUND

Retailers can leverage computer vision (CV) technology to identify items in customer carts and ensure cart contents match corresponding receipts. CV technology can be used to identify some items from images of the cart's items. However, CV technology frequently fails to recognize all items in an image. In such cases, the CV model can be retrained using images randomly sampled from larger image payloads and manually labeled for use as training data. However, random sampling frequently leads to over-sampling of some commonly occurring items and under-sampling of other less commonly encountered items. Images of under-sampled items can be manually identified; however, such manual searches through potentially vast quantities of image data can be a labor-intensive, time-consuming, inefficient, expensive, and potentially cost-prohibitive process.

### SUMMARY

The disclosed examples are described in detail below with reference to the accompanying drawing figures listed below. The following summary is provided to illustrate some examples disclosed herein.

Disclosed are various systems and methods for sampling item data. One such method includes receiving, for each of a plurality of items, a recognition rate corresponding to a rate of success of correlation between: image data of the item captured by an image capture device, and an identified selection of the item from item selection data generated by an item tracker configured to generate the item selection data for lists of selected items. The method further includes determining, from the plurality of items, a plurality of target items having recognition rates failing to satisfy a recognition threshold; identifying, from the item selection data, a plurality of candidate items lists each including at least one of the plurality of target items; determining, by the computing device, a group of top items lists from the plurality of candidate items lists; and retrieving, by the computing device, image data associated with the top selected-items lists.

### BRIEF DESCRIPTION OF THE DRAWINGS

The disclosed examples are described in detail below with reference to the accompanying drawing figures listed below:

FIG. 1 is a block diagram illustrating an example system for sampling item data;

FIG. 2 is a block diagram illustrating an example system, substantially similar to the system of FIG. 1, for sampling item data;

FIG. 3 is a block diagram illustrating item data received and processed by a storage device of the system of FIG. 2;

FIG. 4 is a block diagram illustrating how target items are identified by the system of FIG. 2;

FIG. 5 is a block diagram illustrating how item lists including target items are selected using the system of FIG. 2;

FIG. 6 is a block diagram illustrating how image data corresponding to the selected items lists is retrieved using the system of FIG. 2;

FIG. 7 illustrates how a cluster model of the system of FIG. 2 groups related images into image clusters;

FIG. 8 illustrates how a label application of the system of FIG. 2 is used to label image clusters; and

FIG. 9 is a flowchart illustrating a method for sampling item data, such as by using the system of FIG. 1 or the system of FIG. 2, for example.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some embodiments, . . . ” For brevity and clarity of presentation, this implied leading clause is not repeated ad nauseum.

In intelligent retail environments, using computer vision technology to recognize items purchased by a customer is currently one of the most challenging tasks involved in confirming that the items taken from a retail facility by the customer match the items on the customer's receipt. This task is made even more challenging by collecting the data for labeling needed to update product signatures, as this can involve analyzing data from hundreds or even thousands of retail facilities, which can amount to millions of transactions and numerous images associated with each transaction. The data could be sampled at random, but that would lead to inaccurate data that is not necessarily representative of the problem items that the computer vision technology is actually struggling to identify on a consistent basis. Moreover, sampling the numerous transactions and associated images available to identify instances of a relatively small number of the unrecognized items can involve processing substantial amounts of data, which can exceed limited data storage, processing, and labeling capacities while further increasing system resource consumption.

Aspects of the disclosure solve multiple problems that are necessarily rooted in computer technology, and render use of computing platforms more efficient by providing improved system and methods for sampling item data so that data related to a target item can be identified, analyzed, and labeled efficiently and without overwhelming computing, storage, a and labeling resources. Specifically, some embodiments allow for a computing device to use item recognition data to determine target items that a computer vision technology application or model is consistently failing at identifying. The computing device then identifies transactions that include the target item and retrieves images associated with the identified transactions. The computing device can then format the images and send them to a labeling application where the images can be labeled as belonging to the target item. The labeling information can be used to update the product signature for the target item, and thereby improve the computer vision technology model's accuracy in identifying the target item. Thus, the system allows for precise and efficient sampling of transaction-related data and lessening the amount of storage space and processing power for providing accurate item labels to item image data. Further, the system lessens filtering of unneeded or unnecessary data at the labeling stage, thereby improving efficiency of labeling efforts, which can be associated with a limited labeling capacity.

In some embodiments, the system identifies target items from a plurality of items lists. The target items include underrepresented items and/or frequently unrecognized items from associated image data. In this manner, the system is able to more closely tailor sampling efforts towards underrepresented items rather than performing blind sampling which is likely to include large quantities of over-sampled items and items which are already sufficiently represented in the labeled training data. In this manner, the system reduces data storage resource usage by reducing the number of images selected and stored for use in training data as well as further improving the accuracy of sampling.

In other embodiments, the system determines a number of top items lists from a plurality items lists each including at least one target item. This enables the system to retrieve images related to the target items by focusing on only certain top item lists, which further reduces processor and network bandwidth usage by focusing analysis to top item lists rather than every list that includes a target item.

In other embodiments, the system retrieves image data associated with the top items lists. This reduces the number of images retrieved by the system and focuses image retrieval and image storage to the images associated with target items, thereby reducing network bandwidth usage and further reducing error rates associated with sampling images for ML model training purposes.

In still other embodiments, the system delivers clusters of similar images related to the top items lists to a labeling application for item identification and labeling, such that the labeling application is provided with focused images related to only the top item lists rather than vast quantities of images related to all item lists or all item lists including a target item, and further delivers the images in clusters or grouping of related images. Thereby, the system reduces the processor usage and labor-intensive efforts related to image labeling.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

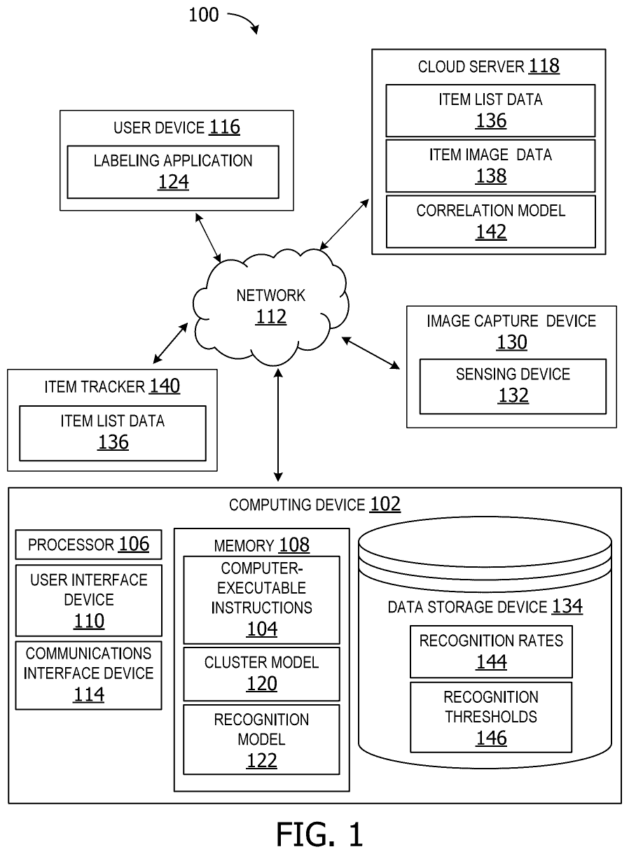

FIG. 1 illustrates an exemplary block diagram of a system 100 for sampling item data. In the example of FIG. 1, computing device 102 represents any device executing computer-executable instructions 104 (e.g., as application programs, operating system functionality, or both) to implement the operations and functionality associated with the computing device 102. Computing device 102 can represent a group of processing units or other computing devices. In some embodiments, the computing device 102 has at least one processor 106 and a memory 108. Computing device 102, in other embodiments includes a user interface device 110.

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, processor 106 is programmed to execute instructions such as those illustrated in the figures.

The computing device 102 further has one or more computer-readable media such as the memory 108. The memory 108 includes any quantity of media associated with or accessible by the computing device 102. The memory 108 in these examples is internal to computing device 102 (as shown in FIG. 1). In other embodiments, the memory 108 is external to the computing device (not shown) or both (not shown). The memory 108 can include a read-only memory and/or memory wired into an analog computing device.

The memory 108 stores data, such as one or more applications, such a cluster model 120 configured to group image data into groups of related images, such as image data received from image capture device 130, for example; and a recognition model 122 configured to determine success rates related to item identifications from images captured by image capture device 130. The applications, when executed by processor 106, operate to perform functionality on the computing device 102. The applications can communicate with counterpart applications or services such as web services accessible via a network 112 or multiple communication networks 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

Network 112 is implemented by one or more physical network components, such as, but without limitation, routers, switches, network interface cards (NICs), and other network devices. Network 112 is any type of network for enabling communications with remote computing devices, such as, but not limited to, a local area network (LAN), a subnet, a wide area network (WAN), a wireless (Wi-Fi) network, or any other type of network. In this example, network 112 is a WAN, such as the Internet. However, in other embodiments, the network 112 is a local or private LAN.

In some embodiments, system 100 optionally includes a communications interface device 114. The communications interface device 114 includes a network interface card and/or computer-executable instructions (e.g., a driver) for operating the network interface card. Communication between the computing device 102 and other devices, such as but not limited to user device 116, image capture device 130, and item tracker 140 can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. User device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also host a labeling application 124 for labeling image clusters generated by cluster model 120.

Image capture device 130 represents any device executing computer-executable instructions. The image capture device 130 includes at least one processor, a memory, and a sensing device 132 configured to gather image data for items of a facility.

Item tracker 140 represents any device executing computer-executable instructions. The item tracker 140 includes at least one processor and a memory and is configured to generate items list data 136 related selected items of a facility.

The cloud server 118 is a logical server providing services to the computing device 102 or other clients, such as, but not limited to, the user device 116, item tracker 140, and image capture device 130. Cloud server 118 is hosted and/or delivered via the network 112. In some non-limiting examples, cloud server 118 is associated with one or more physical servers in one or more data centers. In other embodiments, the cloud server 118 is associated with a distributed network of servers. Cloud server 118 can store item list data 136 generated by tracker 140 and item image data 138 generated by image capture device 130. Additionally, cloud server 118 can host a correlation model 142 configured to determine correlations and associations between the item list data 136 and the item image data 138.

The system 100 can optionally include a data storage device 134 for storing data, such as, but not limited to, recognition rates 144 determined by recognition model 122 related to correlation model's 142 ability to recognize items from item image data 138; and recognition thresholds 146 related to acceptable thresholds values for recognition rates 144. The data storage device 134 can include one or more different types of data storage devices, such as, for example, one or more rotating disks drives, one or more solid state drives (SSDs), and/or any other type of data storage device. The data storage device 134 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 134 includes a database.

The data storage device 134 in this example is included within the computing device 102, attached to the computing device, plugged into the computing device, or otherwise associated with the computing device 102. In other embodiments, data storage device 134 includes a remote data storage accessed by the computing device via the network 112, such as a remote data storage device, a data storage in a remote data center, or a cloud storage. Similarly, although cluster model 120 and recognition model 122 are depicted within computing device 102, according to various embodiments, cluster model 120 and recognition model 122 are implemented on a remote or cloud memory storage.

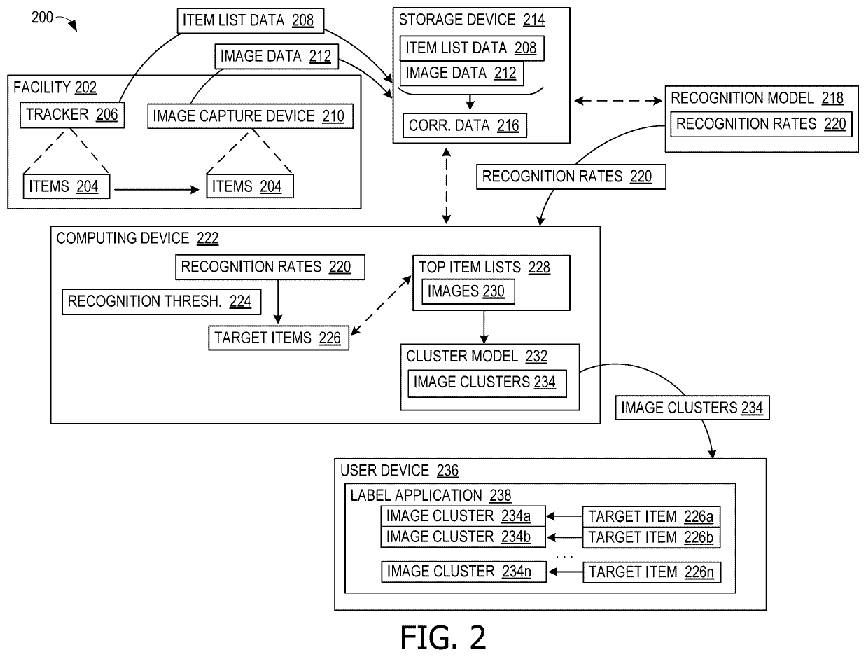

FIG. 2 is a block diagram illustrating a system 200, substantially the same as system 100. System 200 includes a facility 202 where items can be stored. For example, according to various embodiments, facility 202 is a retail facility and the items stored therein are items or products that are offered for sale to customers of the facility 202 by a retailer. A group of items, such items as illustrated by items 204, are selected by a customer for purchase. The items 204 are then processed by an item tracker 206 (substantially the same as item tracker 140) that generates item list data 208 related to the items 204. Specifically, in some example, tracker 206 is a point-of-sale (POS) terminal of facility 202 where a universal product code (UPC) of each of the items 204, such as a barcode for example, is scanned by the item tracker 206 to generate transaction data relating to items purchased during a particular transaction. Accordingly, as will be discussed in greater detail throughout this application, item list data 208 can include lists of items 204 purchased for given transactions performed at item tracker 206. That is, item list data 208 can comprise transaction receipts of various transactions performed at item tracker 206. While one item tracker 206 is illustrated in facility 202, those with skill in the art will understand that facility 202 can comprise numerous item tracker 206, according to various embodiments of this disclosure.

Items 204 are processed by an image capture device 210 (substantially the same as image capture device 130) which generates image data 212 related to items 204. Specifically, as will be discussed in greater detail below, image data 212 can comprise numerous images of items 204 taken by various cameras of image capture device 210. Although FIG. 2 depicts capturing images of items 204 using image capture device 210 after the items 204 are processed item tracker 206, those with skill in the art will recognize that, according to various embodiments, image capture device 210 captures images of items 204 prior to or simultaneous with item tracker 206 processing items 204.

As shown, item list data 208 and image data 212 are delivered to a storage device 214 (substantially the same as cloud server 118). Using item list data 208 and image data 212 storage device 214 generates correlation data 216 that correlates the various images from image data 212 to specific item lists or transactions of item list data 208. According to various embodiments, as will be discussed in greater detail below, storage device 214 employs a correlation model that implements computer vision techniques and models where specific items from a group of items are recognized by the correlation model from image data 212 and matched to a corresponding transaction or items list of item list data 208 based on determining which of the items list or transactions is a best fit for the items recognized in the images of the group of items.

Correlation data 216 is analyzed by a recognition model 218 (substantially the same as recognition model 122) configured to determine how effective the computer vision techniques are at identifying the various items 204 from image data 212. As shown, recognition model 218 generates recognition rates 220 describing the success rate of the computer vision techniques at recognizing various items from image data 212. The recognition rates 220 are then delivered to a computing device 222 for further processing. As shown, computing device 222 is operably coupled with recognition model 218 and storage device 214 to allow for communication of data between the devices. However, according to various embodiments, one or both of storage device 214 and recognition model 218 are included as part of computing device 222.

Computing device 222 applies a recognition threshold 224 to recognition rates 220 to determine items with recognition rates falling below the recognition threshold 224, and labels the items failing to satisfy recognition threshold 224 as target items 226. As will become clearer throughout this disclosure, computing device 222 identifies target items 226 so that data from item tracker 206 and image capture device 210 can be efficiently sampled to locate images of target items 226 such that the images can be labeled or otherwise categorized accordingly as belonging to the target item 226 and can be utilized in updating a product signature of the target item 226 for future training or operation of the computer vision techniques and models to improve future identification of the target items 226.

After identifying target items 226, computing device 222 identifies item lists from item list data 208 that include target items 226 on the item lists. Computing device 222 then ranks or orders the item lists to generate a group of top item lists 228. Using correlation data 216 computing device 222 further retrieves images 230 corresponding to each of the item lists included in the top item lists 228.

The top item lists 228 and their corresponding images 230 are then delivered to a cluster model 232 (substantially the same as cluster model 120) configured to group images into various image clusters 234 of similar or related images. According to various embodiments, cluster model 232 can utilize or comprise a large language model (LLM), machine learning (ML), artificial intelligence (AI), and/or generative AI model able to identify similarities in various images and group or cluster the images according to the similarities detected in the image clusters 234.

Computing device 222 delivers the image clusters 234 to a user device 236 (substantially the same as user device 116) hosting a label application 238 (substantially the same as label application 124) whereby the various image clusters 234 (as shown, image cluster 234a, 234b, . . . 234n) can be labeled as belonging to a certain target item 226 (target item 226a, 226b, . . . 226n). According to some embodiments, label application 238 is utilized by a human user that labels each image cluster of image clusters 234 as belonging to a certain target item of target items 226. As previously mentioned, once the images are labeled as belonging to a certain target item, the labeled images can be to update a product signature used by computer vision techniques and models as training data or as reference data to improve accuracies in identifying the target items 226 from image data 212.

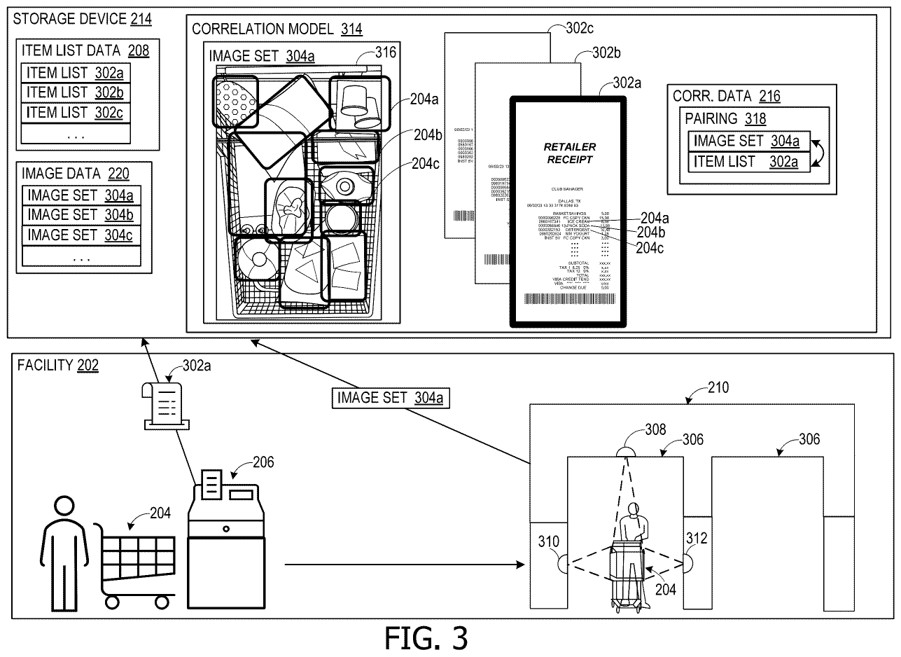

FIG. 3 illustrates data received and processed storage device 214. As shown, a shopper takes a group of items 204 and purchases items 204 using item tracker 206, which, as shown here, is a checkout register or other POS terminal. Item tracker 206 is used to scan the UPC associated with each of the items 204 and thereby generates a list 302 of the items 204 purchased during a transaction. List 302 can comprise a copy of the receipt associated with the transaction. For illustrative purposes, list 302a is used to show a specific transaction. As shown, list 302a is delivered to storage device 214 and is stored as part of item list data 208 with other lists 302 associated with other transactions.

The shopper proceeds to exiting facility 202 and walks through image capture device 210 with their items 204. FIG. 3 depicts an exemplary image capture device 210 that includes two bays 306 that shoppers can pass through, each bay 306 including a plurality of cameras 308, 310, 312 configured to capture images of items 204 as the user walks through the bay 306. Although FIG. 3 depicts capturing images of items 204 using image capture device 210 after the items 204 are processed by item tracker 206, those with skill in the art will recognize that, according to various embodiments, image capture device 210 can captures images of items 204 prior to or simultaneous with item tracker 206 processing items 204.

Using all of the images captured by cameras 308, 310, 312, image capture device 210 creates an image set 304 comprising all of the images taken by the cameras 308, 310, 312 for a given group of items 204. For illustrative purposes, image set 304a is used to show a specific image set. As shown, image set 304a is delivered to storage device 214 and is stored as part of image data 212 with other image sets 304 associated with other transactions.

Storage device 214 utilizes a correlation model 314 (substantially the same as correlation model 142) to correlate or associate each the image sets 304 with a corresponding one of the item lists 302. As an illustrative example, image set 304a is shown as being processed by correlation model 314. Correlation model 314 can comprise various computer vision techniques and models for identifying the items 204 depicted in the images of image set 304a. As shown an image 316 of image set 304a shows a top-view of items 204 taken using camera 308, and those with skill in the art will recognize that correlation model 314 utilizes various images capturing different perspectives of the group of items 204, such as top-, side-, front-, rear-, and bottom views, for example, together in identifying the different items. As shown with bold outlines, correlation model 314 identifies various items, such as items 204a, 204b, and 204c, from image set 304a.

Correlation model 314 further analyzes items included on the various lists 302 and can determine which list 302 includes items corresponding to the items identified in the analyzed image set 304. As shown in this illustrative example, correlation model 314 identifies that list 302a is associated with image set 304a by matching the various items identified in image set 304a (such as items 204a, 204b, 204c, etc.) with the items included on list 302a. As part of correlation data 216, correlation model 314 includes various pairings, such as pairing 318 which identifies the correlation between an image set 304a and a list 302a. That is, each pairing 318 indicates the image set 304a associated (or paired) with an item list 302a, and vice versa, as determined by the correlation model 314.

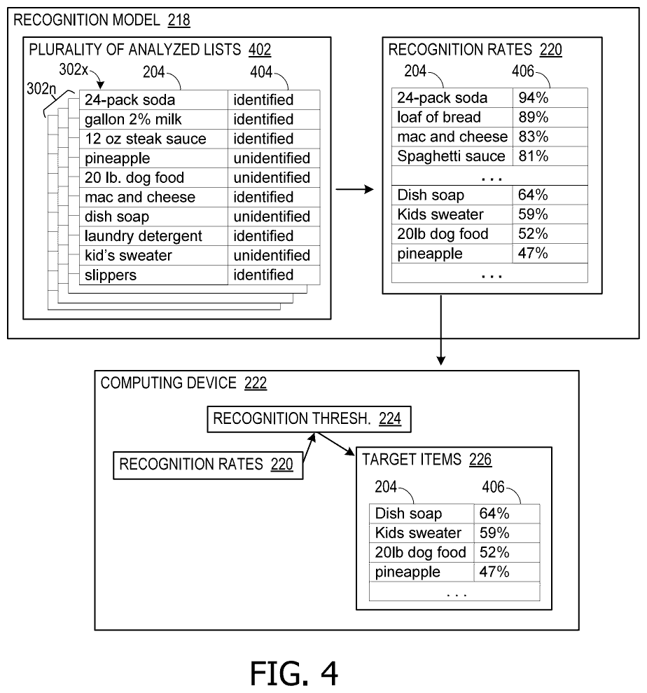

Referring to FIG. 4, recognition model 218 receives various data prepared and processed by correlation model 314, including a plurality of analyzed lists 402. During the processes discussed above in correlating lists 302 with image sets 304, for each list 302 analyzed, correlation model 314 determines whether or not the items on the list 302 are recognized or identified in the corresponding image set 304. As shown with an example list 302x, for each item 204, correlation model 314 determines a recognition status 404 for each item 204 based on whether the item is recognized by correlation model 314 in the image set associated with the list 302. As shown, recognition status 404 can be “recognized” indicating the item 204 is recognized or identified in the corresponding image set 304, or “unrecognized” indicating the item 204 is not recognized or not identified in the corresponding image set 304. The plurality of analyzed lists 402 can include a plurality of lists 302n with the corresponding recognition status 404 for each item 204 in each list 302.

Those with skill in the art will understand that an item 204 can be labeled as “unrecognized” by correlation model 314 for any of a number of reasons. For example, the unrecognized item can be a new item, such as an item new to the retailer or facility 202, and thus associated with an absence of historic image data for identifying the new item by correlation model 314. For example, the unrecognized item can be a rare item that is rarely selected for processing by tracker 206 and for which the correlation model 314 has an insufficient quantity of historic image data for identifying the rare item. For example, the unrecognized item can be a uniquely-shaped item with a plurality of unique faces that the correlation model 314 has an insufficient quantity of historic image data related to the unique faces for identifying the uniquely-shaped item.

Using this data, recognition model 218 determines recognition rates 220. As shown, from the plurality of lists 302n, recognition model 218 can determine how often each item it accurately identified or recognized by correlation model 314, and provide each item with a corresponding recognition rate value 406. As an example, item 204 named “24-pack soda” has a recognition rate value 406 of 94%, meaning, in some embodiments, that the item 204 named “24-pack soda” is accurately recognized from the image set 304 paired to the lists 302 (in pairing 318) where item 204 “24-pack soda” is included on the list 302 94% of the time.

As those with skill in the art will understand, recognition rate values 406 can be calculated according to any of a number of variables. For example, recognition rate values 406 can be determined based on factors such as, the perspective of the image used to identify the item (top-view, side-view, bottom-view, etc.); the item's location on the cart in the images (main basket, bottom rack, etc.); and the facility from which the images originate (facility-specific factors can effect image recognition quality—such as facility lighting, camera positions, carts utilized, etc.). Those with skill in the art will recognize these are some of numerous factors that could be used in calculating or refining recognition rate values 406.

Recognition rates 220 are then provided to computing device 222 where a recognition threshold 224 is applied to recognition rates 220 to determine target items 226. Any items 204 having a recognition rate value 406 that fails to satisfy recognition threshold 224 are identified as target items 226. As shown, in this illustrative example, the recognition threshold 224 may have been 70%, so all items 204 with a recognition rate values 406 less than 70% are included as target items 226. Recognition threshold 224 can be a predetermined value decided by an operator of system 200 and can be any value. Additionally, recognition threshold 224 can be determined based on various variables, such as the variable discussed above in determining recognition rate values 406.

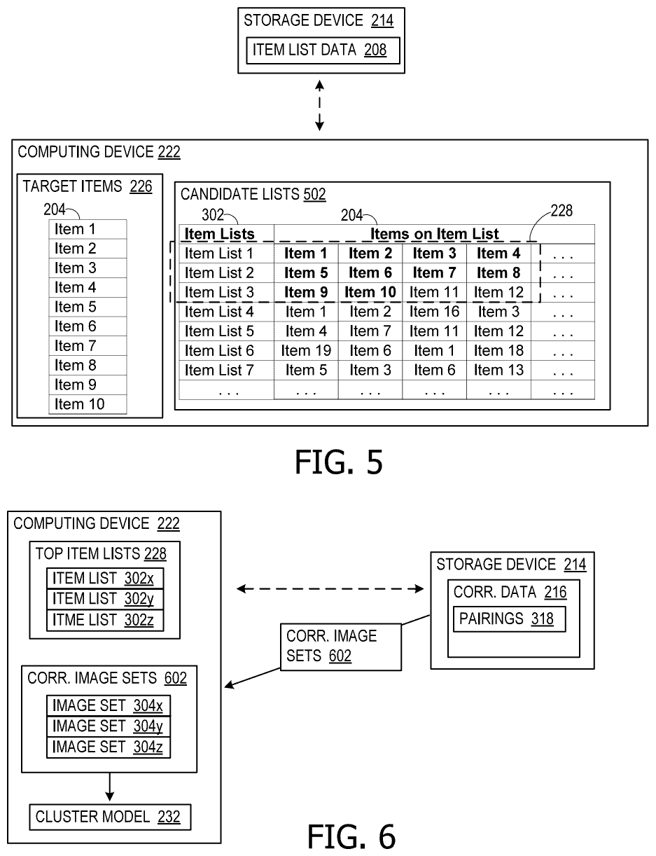

Referring to FIG. 5, after determining target items 226, computing device 222 references item list data 208 stored at storage device 214 and thereby identifies lists 302 that include any of the target items 226. Computing device 222 includes all lists 302 that include at least one of the target items 226 as part of candidate lists 502. For further processing, from candidate lists 502, computing device 222 identifies a group of top item lists 228, which, in some embodiments, is a group of the lists 302 of candidate lists 502 that include all items of the target items 226. In this illustrative example, all target items 226 titled “Item 1”-“Item 10” are included in top item lists 228 when item lists 302 titled “Item List 1”-“Item List 3” comprise the top item lists 228.

Those with skill in the art will understand that identifying lists 302 for including as part of top item lists 228 can be determined by computing device 222 by using any of a number of factors. For example, according to some embodiments, top item lists 228 are determined by selecting a minimum number of lists 302 from candidate lists 502 needed for capturing each of the plurality of target items 226 in the top item lists 228. In some embodiments, lists 302 from candidate lists 502 are selected to be in top item lists 228 based on the number of target items 226 included on the list. For example, lists 302 with a greater number of target items 226 may be prioritized over those with less. In some embodiments, a greedy approach is utilized where computing device 222 first sorts the candidate lists 502 based on their coverage of target items 226, and then keeps selecting additional lists from candidate lists 502 one by one until all items from target items 226 are covered by top item lists 228. In some embodiments, each of the target items 226 are covered by a single list of candidate lists 502 included in top item lists 228, and in some embodiments, multiple of candidate lists 502 are selected per any or each of the target items 226.

Referring to FIG. 6, after determining top item lists 228, computing device 222 references correlation data 216 and specifically pairings 318 to retrieve the image sets 304 associated with the lists 302 included on top item lists 228, as indicated by corresponding image sets 602. As shown in this illustrative example, as part of corresponding image sets 602, computing device 222 retrieves an image set 304x, 304y, 304z corresponding to each list 302x, 302y, 302z included on top item lists 228 according to the defined associations in parings 318, as previously discussed.

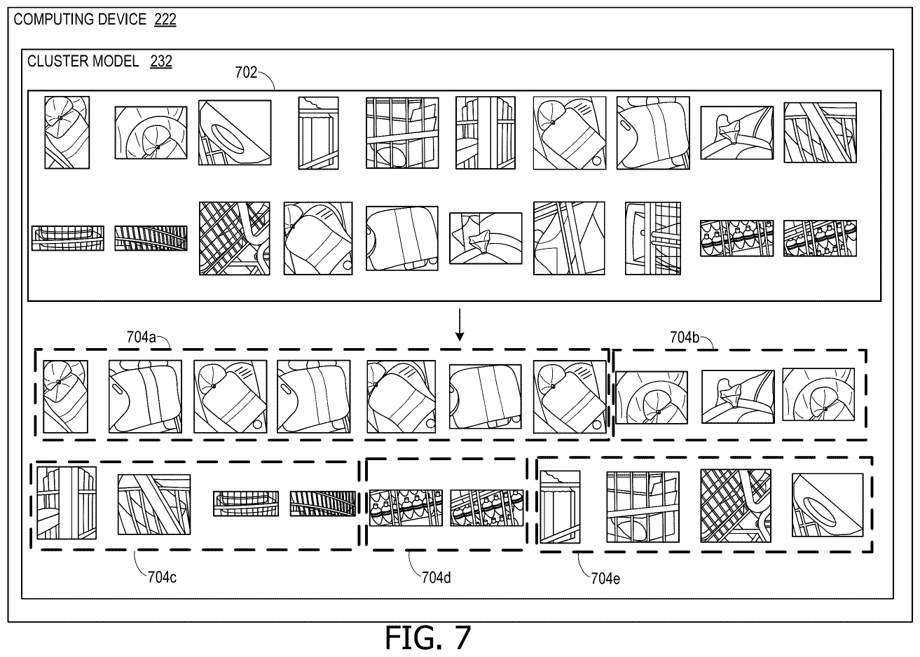

FIG. 7 provides an illustrative example of how computing device 222 utilizes cluster model 232 to generate image clusters or groupings. Here, cluster model 232 starts with an image set 702, substantially the same as image sets 304 previously discussed. As shown, image set 702 contains a plurality of formatted images taken of a user's cart and the items held therein. Cluster model 232 is configured to identify similarities between the plurality of images and group or cluster the images according to their similarities. As shown cluster model 232 groups the images of image set 702 in various image clusters 704a, 704b, 704c, 704d, and 704e. According to various embodiments, each cluster can be a different item 204, including target items 226, contained in the images of the image set 702. As previously discussed, according to various embodiments, cluster model 232 can utilize ML or AI models configured to group images according to identified similarities between the images. Cluster model 232 can perform various other actions that aid in forming image clusters 234. For example, cluster model 232 can perform sampling within mage clusters 234 to eliminate substantially similar images from an image clusters 234.

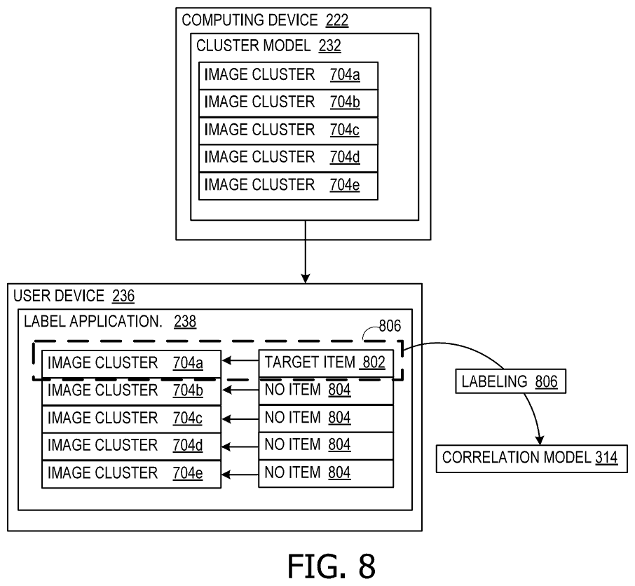

Referring to FIG. 8, the cluster model 232 delivers the image clusters 234 to a label application 238, which can be hosted on a user device, such as user device 236. There, each image cluster 234 can be analyzed and labeled accordingly. As previously mentioned, according to some embodiments, a human user interacting with label application 238 performs the labeling of the image clusters 234. However, in other embodiments, a labeling model or AI program can be used to perform or assist in performing the labeling described. In keeping with the example discussed in FIG. 7, image clusters 704a-704e are depicted in FIG. 8. As can be seen in FIG. 7, image cluster 704a includes images of a package of hotdog buns, while image clusters 704b-704e do not show a clear depiction of any product. The hotdog buns in cluster 702a can be a target item 802 (substantially the same as a target item 226), and thus labeled as such using label application 238. Since image clusters 704b-704e do not correspond to any item, label application 238 can be used to label the image clusters 704b-704e with a no item 804 designation.

Thus, the labeling of image cluster 704a as a target item 802 can be described as a positive labeling 806. Positive labeling 806 can then be used to update a product signature associated with the target item and used by a computer vision model for identifying target item 802 in future images being processed by the computer vision model. That is, the images of image cluster 704a being labeled as depicting target item 802 can be used in training or a computer vision model, including training for an ML, AI, or generative AI computer vision model. For example, in some embodiments, positive labeling 806 is delivered to correlation model 314 to use in identifying target item 802 from image data 212. In some embodiments, correlation model 314 can remove images from positive labeling 806 that are substantially similar to images already collected for the target item 802 and thereby focus on more diverse images included in positive labeling 806.

As those with skill in the art will understand, retailers may have limited resources dedicated to supporting labeling efforts. Accordingly, labeling images can become a bottleneck in the process if the labeling resources are overwhelmed by the amount of raw images supplied to the labeling resources. Accordingly, those with skill in the art will recognize how, in addition to providing efficiencies an improvements to data storage and computing capacities, the systems and methods of this disclosure further reduce the amount of labeling resources required by, through precise sampling of image data, provide image sets of transactions known to include target items.

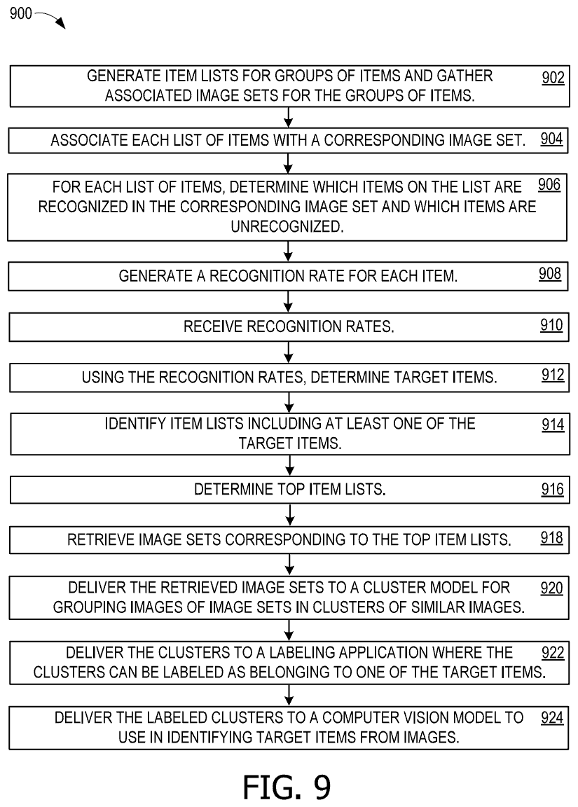

FIG. 9 is a flowchart illustrating a method 900 of sampling item list data and corresponding image data, such as item list data 208 and image data 212. Method 900 can begin at block 902 by generating item list data 208 using item tracker 206 and generating image data 212 using image capture device 210. Method 900 can continue to block 904 where correlation model 314 generates pairings 318 that correlate each item list 302 included in item list data 208 with an associated image set 304 included in image data 212. Method 900 can continue to block 906 by correlation model 314 determining which items 204 from each list 302 are recognized or positively identified in the associated image set 304 and which items are unrecognized or not positively identified in the associated image set 304. Method 900 can continue to block 908 by recognition model 218 generating recognition rates 220 which includes determining a recognition rate value 406 for each item 204 included on the lists 302.

Method 900 can continue to block 910 where computing device 222 receives recognition rates 220 and then to block 912 where computing device 222, by applying a recognition threshold 224 to recognition rates 220, determines target items 226, which are items that have a recognition rate value 406 failing to satisfy the recognition threshold 224. Method 900 can continue to block 914 where computing device 222, using item list data 208, identifies candidate lists 502 that each include at least one of the target items 226. Method 900 can continue to block 916 wherein computing device 222 determines top item lists 228 from candidate lists 502. Top item lists 228 can be determined based on the various calculations and determination methods previously discussed, such as in the discussion of FIG. 5.

Method 900 can continue to block 918 where, using correlation data 216 and pairings 318, computing device 222 retrieves corresponding image sets 602 corresponding to the top item lists 228. Method 900 can continue to block 920 where computing device 222 delivers the corresponding image sets 602 to cluster model 232 where the images of corresponding image sets 602 are grouped into image clusters 234 of similar images, such as image clusters 704a-704e, for example. Method 900 can continue to block 922 where the image clusters 234 are delivered by computing device 222 to a label application 238 where the image clusters 234 can be labeled as including images depicting target items 226, such as positive labeling 806, for example. Method 900 can continue to block 924 where positive labelings 806 are delivered to a computer vision model to update product signatures associated with target items 226 for use in future identifications of target items 226 in image data 212, such as by delivering the positive labelings 806 to correlation model 314, for example.

While method 900 illustrates blocks 902-924 occurring in certain orders, those with skill in the art will understand that blocks 902-924 can be performed according to any of a number of orders without departing from the scope of this disclosure. Additionally, according to various embodiments, method 900 can include more or less blocks than the blocks 902-924 depicted.

Some of the embodiments, as described above, include capturing, generating or otherwise obtaining images and image data which is analyzed to identify objects of interest. The images do not include images of users or other individuals within a retail facility or other environment in which the images are captured. Any images having human users inadvertently included within the images are removed from the images by cropping the images such that only inanimate objects of interest, such as shopping carts and products, remain in the cropped images. Images of users and images of objects which are not of interest are deleted or otherwise discarded. The cropped images containing only the objects of interest are then analyzed to identify and label the objects of interest within the cropped images.

### Additional Examples

In an example scenario, the systems herein (such as system 100 and 200, for example) are utilized by a retailer utilizing various retail facilities for retailing items to customers. As customers leave the retail facilities with their purchased items, images are taken of the items and are analyzed by the retailer using computer vision technology to identify items from the images, and compare the identified items to corresponding transaction data. The retailer can use the data taken across the various retail facilities and determine target items that are commonly unrecognized by the computer vision technology, or items that are underrepresented in the current data. The retailer can then sample the data taken across the various facilities, according to the various sampling methods systems disclosed herein, to achieve focused data related to the target images so that product signatures related to the target items can be updated and thereby improve future recognition of the target items by the computer vision technology.

Alternatively, or in addition to the other examples described herein, examples include any combination of the following:
delivering image data associated with top items lists to a cluster model configured to group images of the image data associated with the top items lists in clusters of related images.
a cluster model that comprises a machine learning (ML) model.
delivering clusters of related images to a labeling application where the clusters are labeled as belonging to one of a plurality of target items.
determining a group of top items lists by selecting a minimum number of candidate items lists needed for capturing each of a plurality of target items in the group of top items lists.
determining a group of top items lists based on a number of the target items included in each of the plurality of candidate items lists.
recognition rates failing to satisfy a recognition threshold is based on the target item being: a new item for which a computer vision model has an absence of historic image data for identifying the new item; a rare item that is rarely selected for which the computer vision model has an insufficient quantity of historic image data for identifying the rare item; or a uniquely-shaped item with a plurality of unique faces that the computer vision model has an insufficient quantity of historic image data related to the unique faces for identifying the uniquely-shaped item.

At least a portion of the functionality of the various elements in FIG. 1 can be performed by other elements in FIG. 1, or an entity (e.g., processor 106, web service, server, application program, computing device, etc.) not shown in FIG. 1.

In some examples, the operations illustrated in FIG. 9 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of sampling item data, the method comprising: receiving, from a recognition model for each of a plurality of items by a computing device, a recognition rate corresponding to a rate of success of correlation between: image data of the item captured by an image capture device, and an identified selection of the item from item selection data generated by an item tracker configured to generate the item selection data for lists of selected items; determining, from the plurality of items by the computing device, a plurality of target items each having a recognition rate failing to satisfy a recognition threshold; identifying, from the item selection data by the computing device, a plurality of candidate items lists each including at least one of the plurality of target items; determining, by the computing device, a group of top items lists from the plurality of candidate items lists; and retrieving, by the computing device, image data associated with the top items lists.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Although described in connection with an example computing device 102, 222 examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for sampling item data, comprising:
an item tracker configured to generate item selection data for lists of selected items;
an image capture device configured to capture image data of selected items; and
a computer-readable medium storing instructions that are operative upon execution by a processor to:
receive, for each of a plurality of items, a recognition rate corresponding to a rate of success of correlation between image data of the item and an identified selection of the item from the item selection data from an item recognition model utilizing the item selection data and the image data;
determine, from the plurality of items, a plurality of target items each having a recognition rate that fails to satisfy a recognition threshold;
identify, from the item selection data, a plurality of candidate items lists each including at least one of the plurality of target items;
determine a group of top items lists from the plurality of candidate items lists; and
retrieve image data associated with the top items lists.

2. The system of claim 1, wherein the computer-readable medium further stores instructions operative by the processor to:
deliver the image data associated with the top items lists to a cluster model configured to group images of the image data associated with the top items lists in clusters of related images.

3. The system of claim 2, wherein the cluster model is a machine learning (ML) model.

4. The system of claim 2, wherein the computer-readable medium further stores instructions operative by the processor to:
deliver the clusters of related images to a labeling application where the clusters are labeled as belonging to one of the plurality of target items.

5. The system of claim 1, wherein the computer-readable medium further stores instructions operative by the processor to:
determine the group of top items lists by selecting a minimum number of candidate items lists needed for capturing each of the plurality of target items in the top items lists.

6. The system of claim 1, wherein the computer-readable medium further stores instructions operative by the processor to:
determine the group of top items lists based on a number of the target items included in each of the plurality of candidate items lists.

7. The system of claim 1, wherein the recognition rates that fail to satisfy the recognition threshold is based on the target item being:
a new item for which a computer vision model has an absence of historic image data for identifying the new item;
a rare item that is rarely selected for which the computer vision model has an insufficient quantity of historic image data for identifying the rare item; or
a uniquely-shaped item with a plurality of unique faces that the computer vision model has an insufficient quantity of historic image data related to the unique faces for identifying the uniquely-shaped item.

8. A method for sampling item data, comprising:
receiving, from a recognition model for each of a plurality of items by a computing device, a recognition rate corresponding to a rate of success of correlation between:
image data of the item captured by an image capture device, and
an identified selection of the item from item selection data generated by an item tracker configured to generate the item selection data for lists of selected items;
determining, from the plurality of items by the computing device, a plurality of target items each having a recognition rate failing to satisfy a recognition threshold;
identifying, from the item selection data by the computing device, a plurality of candidate items lists each including at least one of the plurality of target items;
determining, by the computing device, a group of top items lists from the plurality of candidate items lists; and
retrieving, by the computing device, image data associated with the top items lists.

9. The method of claim 8, further comprising:
delivering, by the computing device, the image data associated with the top items lists to a cluster model configured to group images of the image data associated with the top items lists in clusters of related images.

10. The method of claim 9, wherein the cluster model is a machine learning (ML) model.

11. The method of claim 9, further comprising:
delivering, by the computing device, the clusters of related images to a labeling application where the clusters are labeled as belonging to one of the plurality of target items.

12. The method of claim 8, further comprising:
determining, by the computing device, the group of top items lists by selecting a minimum number of candidate items lists needed for capturing each of the plurality of target items in the group of top items lists.

13. The method of claim 8, further comprising:
determining, by the computing device, the group of top items lists based on a number of the target items included in each of the plurality of candidate items lists.

14. The method of claim 8, wherein the recognition rates failing to satisfy the recognition threshold is based on the target item being:
a new item for which a computer vision model has an absence of historic image data for identifying the new item;
a rare item that is rarely selected for which the computer vision model has an insufficient quantity of historic image data for identifying the rare item; or
a uniquely-shaped item with a plurality of unique faces that the computer vision model has an insufficient quantity of historic image data related to the unique faces for identifying the uniquely-shaped item.

15. A computer-readable medium storing instructions for sampling item, the instructions operative by a processor to:
receive, from an item recognition model for each of a plurality of items, a recognition rate corresponding to a rate of success of correlation between:
image data of the item captured by an image capture device, and
an identified selection of the item from item selection data generated by an item tracker configured to generate the item selection data for lists of selected items;
determine, from the plurality of items, a plurality of target items each having a recognition rate that fails to satisfy a recognition threshold;
identify, from the item selection data, a plurality of candidate items lists each including at least one of the plurality of target items;
determine a group of top items lists from the plurality of candidate items lists; and
retrieve image data associated with the top items lists.

16. The computer-readable medium of claim 15, further storing instructions operative by the processor to:
deliver the image data associated with the top items lists to a cluster model configured to group images of the image data associated with the top items lists in clusters of related images.

17. The computer-readable medium of claim 16, wherein the cluster model is a machine learning (ML) model.

18. The computer-readable medium of claim 16, further storing instructions operative by the processor to:
deliver the clusters of related images to a labeling application where the clusters are labeled as belonging to one of the plurality of target items.

19. The computer-readable medium of claim 15, further storing instructions operative by the processor to:
determine the group of top items lists by selecting a minimum number of candidate items lists needed for capturing each of the plurality of target items in the group of top items lists.

20. The computer-readable medium of claim 15, further storing instructions operative by the processor to:
determine the group of top items lists based on a number of the target items included in each of the plurality of candidate items lists.
